(19) United States
(12) Patent Application Publication
(10) Pub. No.: US 2026/0285777 A1
(43) Pub. Date: Sep. 24, 2026

(54) ALGAE FERTILIZER COMPOSITION AND METHOD OF USING THE SAME

(71) Applicants: Saudi Arabian Oil Company, Dhahran (SA); Aarksee Holding Co W.L.L, Al Seef (BH)

(72) Inventors: Naif Alabdullatif, Khobar (SA); Ahmed Adel Alhomran, Qatif (SA); Naif Nasser Almalki, Khobar (SA); Senthil Chinnasamy, Hidd (BH); Ramachandran Rajeev Kumar, Hidd (BH)

(21) Appl. No.: 19/437,703

(22) Filed: Dec. 31, 2025

Related U.S. Application Data
(60) Provisional application No. 63/740,488, filed on Dec. 31, 2024.

(51) Int. Cl. C05F 11/08; C05F 17/10; C05F 17/60

(52) U.S. Cl. CPC C05F 11/08; C05F 17/10; C05F 17/60

(57) ABSTRACT

The present disclosure provides a fertilizer composition. The fertilizer composition includes cured algae in an amount from 5 wt. % to 50 wt. %, based on a total weight of the fertilizer composition. The fertilizer composition includes sand in an amount from 50 wt. % to 95 wt. %, based on the total weight of the fertilizer composition, where the cured algae comprises algae that is cured in-situ within the fertilizer composition with a solution over a duration such that the algae undergoes microbial decomposition to form the cured algae.

### CROSS-REFERENCE TO RELATED APPLICATIONS

This application claims benefit under 35 USC § 119 (e) of U.S. Provisional Application No. 63/740,488, filed Dec. 31, 2024. The entire disclosure of this application is incorporated by reference herein.

### TECHNICAL FIELD

Embodiments of this disclosure generally relate to fertilizers. More specifically, embodiments of this disclosure relate to an algae fertilizer composition and method of using the same.

### BACKGROUND

Fertilizer is any material of natural or synthetic origin that is applied to soil or plant tissue to supply plant nutrients. Fertilization typically focuses on three main macro nutrients, which include nitrogen (N), phosphorous (P), and potassium (K), as well as supplements for micronutrients. Traditional fertilizer may contain compost, manure, peat moss, harvested minerals, by-products of human-nature industries (e.g., fish processing waste), as well as synthesized materials like single nutrient fertilizers (single N-based fertilizer, single P-based fertilizer, single K-based fertilizer) or multi nutrient fertilizer (NP-based fertilizer, NK-based fertilizer, PK-based fertilizer, NPK-based fertilizer).

### SUMMARY

An aspect of the present disclosure relates to a method. The method includes forming a fertilizer composition by mixing algae and sand. In some embodiments, the algae on a dry weight basis is present in the fertilizer composition in an mount from 5 wt. % to 50 wt. %, based on a total weight of the fertilizer composition. In some embodiments, the sand is present in the fertilizer composition in an amount from 50 wt. % to 95 wt. %, based on the total weight of the fertilizer composition. In some embodiments, the method further includes curing the algae in-situ within the fertilizer composition with a solution over a duration such that the algae undergoes microbial decomposition to form cured algae.

Another aspect of the present disclosure relates to a method. The method includes forming a fertilizer composition by mixing algae with a carbon feedstock, where the fertilizer composition has an initial C:N ratio from 20:1 to 40:1. The method includes composting the carbon feedstock in the fertilizer composition, wherein during composting the carbon feedstock is decomposed to reduce the initial C:N ratio. The method includes curing the algae in-situ in the fertilizer composition with a solution over a duration such that the algae undergoes microbial decomposition to form cured algae. The method includes adding sand to the fertilizer composition, where the cured algae on a dry weight basis is present in the fertilizer composition in an amount from 5 wt. % to 50 wt. %, based on a total weight of the fertilizer composition, and the sand is present in the fertilizer composition in an amount from 5 wt. % to 95 wt. %, based on the total weight of the fertilizer composition.

Yet another aspect of the present disclosure relates to a fertilizer composition. The fertilizer composition includes cured algae on a dry weight basis in an amount from 5 wt. % to 50 wt. %, based on a total weight of the fertilizer composition. The fertilizer composition includes sand in an amount from 5 wt. % to 95 wt. %, based on the total weight of the fertilizer composition. In some embodiments, the cured algae comprises algae that is cured in-situ within the fertilizer composition with a solution over a duration such that the algae undergoes microbial decomposition to form the cured algae.

The details of one or more implementations of the subject matter of this specification are set forth in the Detailed Description, the accompanying drawings, and the claims. Other features, aspects, and advantages of the subject matter will become apparent from the Detailed Description, the claims, and the accompanying drawings.

### BRIEF DESCRIPTION OF DRAWINGS

FIG. 1 is a schematic drawing of a fertilizer composition according to an embodiment of the present disclosure.

FIG. 2 is a schematic flowchart of a method according to an embodiment of the present disclosure.

FIG. 3 is a schematic flowchart of a method according to an embodiment of the present disclosure.

FIG. 4A is a graph illustrating temperature changes observed in a mangrove potting mix with algae (T1-T5) after 5 days of curing.

FIG. 4B is a graph illustrating temperature changes observed in a mangrove potting mix with algae (T1-T5) after 10 days of curing.

FIG. 4C is a graph illustrating temperature changes observed in a mangrove potting mix with algae (T1-T5) after 15 days of curing.

FIG. 4D is a graph illustrating temperature changes observed in a mangrove potting mix with algae (T1-T5) after 30 days of curing.

FIG. 5 is a graph illustrating changes in electrical conductivity (EC) of mangrove potting mix with algae (T1-T5) during curing.

FIG. 6 is a graph illustrating changes in salinity of mangrove potting mix with algae (T1-T5) during curing.

FIG. 7 is a graph illustrating ammonia content in the mangrove potting mix with algae (T1-T5) during curing.

FIG. 8 is a graph illustrating ammonium content in the mangrove potting mix with algae (T1-T5) during curing.

FIG. 9 is a graph illustrating total ammoniacal nitrogen in the mangrove potting mix with algae (T1-T5) during curing.

FIG. 10 is a graph illustrating nitrate content in the mangrove potting mix with algae (T1-T5) during curing.

FIG. 11 is a graph illustrating average shoot length (in cm) of mangrove seedlings in control and treatments.

FIG. 12 is a graph illustrating average survival % of mangrove seedlings in control and treatments.

FIG. 13 is a graph showing average number of leaves in mangrove seedlings in control and treatments.

Like reference numbers and designations in the various drawings indicate like elements.

### DETAILED DESCRIPTION

The fertilizer composition and method described herein are directed to a fertilizer composition comprising cured algae. The provided composition and method provide practical applications and technical advantages that address various technical challenges associated with using algae as a fertilizer for plants.

For example, a first technical challenge associated with using algae in fertilizer is that the algae produces ammonia (NH₃) and ammonium (NH₄⁺) when applied to the plant, which are byproducts of microbial decomposition of the algae. When the concentrations of ammonia and ammonium are high enough in the root zone of the plant, it can lead to toxic conditions. For example, ammonia and ammonium ion toxicity symptoms may include: reduced plant growth, changes in root architecture, decreases in the root/shoot ratio, leaf chlorosis, inhibition of cations (K⁺, Mg²⁺, or Ca²⁺) uptake and consequent changes in plant ion balance, intra-cellular alkalinization, extracellular acidification, inhabitation of root respiration, stimulation of photorespiration, interference with photosynthetic activity, altered expression of ammonia or ammonium assimilating enzymes, altered activity of ammonia or ammonium assimilating enzymes, disruption of hormonal homeostasis, increased oxidative stress, and high energy cost to maintain low levels of cytosolic ammonium content.

A second technical challenge of using algae as a fertilizer is that certain algae (e.g., algae cultivated in saline, brackish, or wastewater sources) contain high salinity and electrical conductivity values. High electrical conductivity and salinity values may inhibit seed germination and root growth. A third technical challenge of using algae as a fertilizer is that the algae decomposes when applied to the plant. Decomposition reactions are exothermic, which may raise the temperature and deplete oxygen in the root zone. As a result, germination and plant growth may be inhibited.

Embodiments of the present disclosure address the aforementioned technical challenges, in part, by forming a fertilizer composition by mixing algae with sand and curing the algae in-situ within the fertilizer composition with a solution over a duration such that the algae undergoes microbial decomposition to form cured algae. Without wishing to be bound to a particular theory, it is contemplated that cured algae surprisingly and unexpectedly: (i) produces less harmful substances (e.g., ammonia and ammonium) when applied to a plant as a fertilizer relative to the same composition comprising uncured algae; (ii) is more stabilized (e.g., depletes less oxygen and raises the temperature within the root zone to a lesser degree) when applied to a plant as a fertilizer relative to the same composition comprising uncured algae; and/or (iii) leeches less salts when applied to a plant as a fertilizer relative to the same composition comprising uncured algae.

Further, embodiments of the present disclosure may use ash-rich, low-quality algal biomass (e.g., marine algae) that is cultivated in in saline, brackish, or wastewater sources. Using ash-rich, low-quality algal biomass may be cheaper to harvest relative to other algal biomass sources, thereby reducing costs. The fertilizer composition and method of the present disclosure provides an economic friendly approach that may replace organic fertilizers like peat moss, animal manure, or compost, offering a nutrient-rich alternative that enhances solid fertility and promotes plant growth. Rich in organic carbon, nitrogen, phosphorous, and essential minerals, the algal biomass improves nutrient retention and supports healthy seedling development, while simultaneously contributing to CO₂ capture and long-term carbon sequestration within mangrove ecosystem. Embodiments of the present disclosure facilitate sustainable agriculture and environmental conservation, particularly in saline and arid environments.

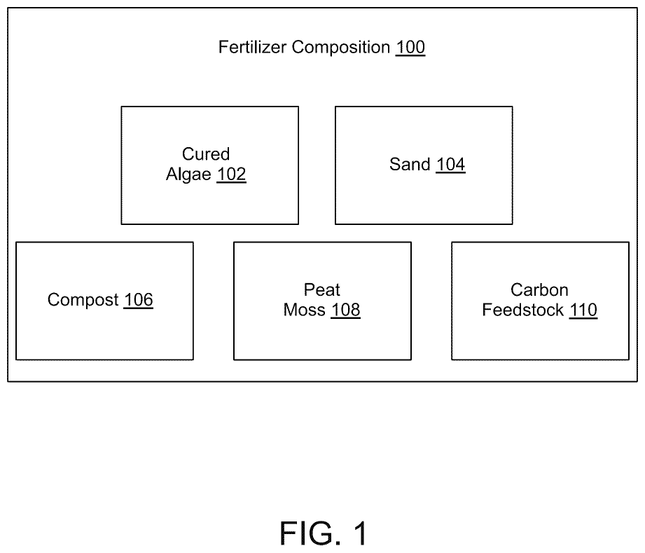

FIG. 1 shows an example fertilizer composition 100. In some embodiments, the fertilizer composition 100 comprises cured algae 102 and sand 104. In some embodiments, the fertilizer composition 100 optionally further comprises compost 106 and/or peat moss 108. As used herein, “cured algae” 102 may refer to algae that has undergone in-situ curing within the fertilizer composition 100 with a solution over a duration such that the algae undergoes microbial decomposition. The cured algae 102 may comprise microalgae. In some embodiments, cured algae 102 may be formed by mixing algae with sand 104 and applying the solution (e.g., water such as fresh water, saline water, brackish water, seawater, or wastewater) over a duration (e.g., at least once per day over one day to 30 days). The in-situ curing at least partially decomposes the algae to form the cured algae 102, which has the benefits discussed above.

In some embodiments, the cured algae 102 may include saline, brackish, wastewater, freshwater algal strains belonging to the taxonomic classes of Chlorophyceae (Green algae), Cryptophyceae (Cryptomonads), Phaeophyceae (Brown algae), Rhodophyceae (Red algae), Xanthophyceae (Yellow-green algae), Dinophyceae (Dinoflagellates), Bacillariophyceae (Diatoms), Chloromonadineae, Euglenophyciae (Euglenoids), Chrysophyceae (Golden algae), Cyanophyceae/Myxophyceae (Blue green algae or Cyanobacteria), or combinations thereof. The algal strains may include, but are not limited to, Anabaena sp., Nostoc sp., Oscillatoria sp., Spirulina sp., Chlorella sp., Scenedesmus sp., Aulosira sp., Cylindrospermum sp., Westiellopsis sp., Calothrix sp., Phormidium sp., Nannochloropsis sp., Asteromonas sp., Dunaliella sp., Tetraselmis sp., Lyngbya sp., Spirogyra sp., Chlorococcum sp., Chroococcus sp., Synechocystis sp., Synochococcus sp., or combinations thereof.

In some embodiments, the cured algae 102 comprises an ash content of at least 10 wt. %, at least 20 wt. %, at least 30 wt. %, at least 35 wt. %, at least 40 wt. %, at least 45 wt. %, at least 50 wt. %, to less than 55 wt. %, less than 60 wt. %, less than 65 wt. %, less than 70 wt. %, less than 75 wt. %, or less than 80 wt. %, based on a total dry matter weight of the cured algae 102. In some embodiments, ash content may be measured by drying cured algae 102 and ashing the cured algae 102 in a furnace at a high temperature (e.g., up to 550° C.) until the organic material is burned off, leaving behind inorganic ash which is weighed to calculate the ash percentage. In some embodiments, the algae used to produce the cured algae 102 is harvested from a body of water with dissolved salts from the body of water.

In some embodiments, the cured algae 102 on a dry weight basis is present in the fertilizer composition 100 in an amount from 5 wt. % to 50 wt. %, based on a total weight of the fertilizer composition 100. For example, the cured algae 102 on a dry weight basis may be present in an amount from at least 5 wt. %, at least 10 wt. %, at least 15 wt. %, at least 20 wt. %, to less than 25 wt. %, less than 30 wt. %, less than 35 wt. %, less than 40 wt. %, or less than 45 wt., based on the total weight of the fertilizer composition 100. The cured algae 102 may be mixed in the fertilizer composition 100 using wet or dry algae.

In some embodiments, the fertilizer composition 100 comprises sand 104. As used herein, “sand” may refer to a naturally occurring granular material composed of finely divided rock and mineral particles. It is defined by size in being finer than gravel and coarser than silt. The composition of sand varies, depending on the local rock sources and conditions, but the most common constituent of sand is silica (silicon dioxide, or SiO₂), usually in the form of quartz. The second most common type of sand is calcium carbonate, for example aragonite.

In terms of particle size, the sand 104 particles range in diameter from 0.0625 mm to 2 mm. An individual particle in this range is termed a sand grain. By definition, sand grains are between gravel (particles ranging from 2 mm to 64 mm) and silt (particles ranging from 0.004 mm to 0.0625 mm). ISO 14688 grades sands as fines, medium and coarse with ranges of 0.063 mm to 0.2 mm to 0.63 mm to 2.0 mm. Sand is also commonly divided into five subcategories based on size: very fine sand (0.0625-0.125 mm diameter), fine sand (0.125-0.250 mm diameter), medium sand (0.250-0.500 mm diameter), coarse sand (0.500-1.0 mm diameter) and very coarse sand (1.0-2.0 mm diameter). These categories of based on the Krumbein phi scale, where size in φ=−log₂ D; wherein D is the particle size in mm. On this scale, for sand the value of φ varies from −1 to +4, with the divisions. In some embodiments, the sand 104 may be very fine sand, fine sand, medium sand, course sand, very course sand, or a combination thereof.

In some embodiments, the sand 104 includes red sand, yellow sand, or a combination thereof. In some embodiments, the red sand includes a bulk density from 1600 to 1630 kg/m³. In one particular example, the red sand has a bulk density of about 1610 kg/m³. In some embodiments, the red sand includes elements selected from the group of: silica (Si), aluminum (Al), oxygen (O), potassium (K), calcium (Ca), iron (Fe), or combinations thereof. In some embodiments, the red sand includes a Si wt. % from 25 wt. % to 35 wt. %, based on a total weight of the red sand. In some embodiments, the red sand includes an Al wt. % from 0.1 to 3.5 wt. %, based on a total weight of the red sand. In some embodiments, the red sand includes an O wt. % from 60 to 68 wt. %, based on a total weight of the red sand. In some embodiments, the red sand includes a Ca wt. % from 0.1 to 3.5 wt %, based on a total weight of the red sand. In some embodiments, the red sand includes an Fe wt. % from 0.1 to 3.5 wt %, based on a total weight of the red sand. In one particular example, red sand has a Si wt. % of about 29.5, an Al wt. % of about 2.1, an O wt. % of about 65, a K wt. % of approximately 0.2, a calcium wt. % of about 0.4, and an iron wt. % of about 2.1, based on a total weight of the red sand. In some embodiments, the red sand has a solar absorptivity percentage from 60 to 70%. In one particular example, the red sand includes a solar absorptivity percentage of about 64.6%.

In some embodiments, yellow sand includes a bulk density of 1530 to 1570 kg/m³. In one particular example, the bulk density is about 1549 kg/m³. In some embodiments, the yellow sand includes elements selected from the group of: silica (Si), aluminum (Al), oxygen (O), or combinations thereof. In some embodiments, the yellow sand includes from a Si wt. % from 30 wt. % to 40 wt. %, based on a total weight of the yellow sand. In some embodiments, the yellow sand includes an Al wt. % from 0.1 to 2.5 wt. %, based on a total weight of the yellow sand. In some embodiments, the yellow sand includes an O wt. % from 60 to 68 wt. %, based on a total weight of the yellow sand. In some embodiments, the yellow sand does not include K, Ca, Fe, or a combination thereof. In one particular example, the yellow sand includes a Si wt. % of about 33.9, an Al wt. % of about 1.2, an O wt. % of about 64.9. In some embodiments, the yellow sand has a solar absorptivity percentage from 35 to 45%. In one particular example, the yellow sand has a solar absorptivity percentage of about 41.5%.

In some embodiments, the sand 104 is present in the fertilizer composition 100 in an amount from 50 wt. % to 95 wt. %, based on a total weight of the fertilizer composition 100. In some embodiments, the sand 104 is present in the fertilizer composition 100 in an amount from at least 5 wt. %, at least 10 wt. %, at least 20 wt. %, at least 30 wt. %, at least 40 wt. %, at least 50 wt. %, at least 55 wt. %, at least 60 wt. %, at least 65 wt. %, at least 70 wt. %, at least 75 wt. %, to less than 80 wt. %, less than 85 wt. %, less than 90 wt. %, or less than 95 wt. %., based on the total weight of the fertilizer composition 100.

In some embodiments, the fertilizer composition 100 comprises compost 106. As used herein, “compost” 106 may refer to a mixture of ingredients that is prepared by decomposing plant waste, food waste, recycling organic materials, and/or manure. The compost 106 is typically rich in plant nutrients and beneficial organisms, such as bacteria, protozoa, nematodes, and fungi. The compost 106 may be prepared by any methods known in the art. For example, it may be prepared in free air, in an aerobic reactor, in an anaerobic reactor, or a combination thereof. In some embodiments, the fertilizer composition 100 may include a carbon feedstock 110. The carbon feedstock 110 may include, but is not limited to, sawdust, shredded waste paper, shredded waste cartons, plant residues, straw, agricultural waste, industrial waste, food waste, aquaculture waste, or a combination thereof.

In some embodiments, the compost 106 is present in an amount from 0.1 wt. % to 25 wt. %, based on the total weight of the fertilizer composition 100. In some embodiments, the compost 106 is present in an amount of at least 0.1 wt. %, at least 1 wt. %, at least 5 wt. %, at least 10 wt. %, to less than 15 wt. %, to less than 20 wt. %, or less than 25 wt. %, based on the total weight of the fertilizer composition 100.

In some embodiments, the fertilizer composition 100 includes peat moss 108. As used herein, “peat moss” 108 may refer to decayed, dried sphagnum moss (e.g., bog moss or quacker moss) that is used as a soil conditioner, and may be derived from mires, bogs, blanket bogs, or a combination thereof. In some embodiments, the peat moss 108 is present in the fertilizer composition 100 in an amount from 0.1 wt % to 25 wt. %, based on the total weight of the fertilizer composition 100. In some embodiments, the peat moss 108 is present in an amount of at least 0.1 wt. %, at least 1 wt. %, at least 5 wt. %, at least 10 wt. %, to less than 15 wt. %, to less than 20 wt. %, or less than 25 wt. %, based on the total weight of the fertilizer composition 100.

As discussed above, when exposed to water and/or a plant, the provided fertilizer composition 100 comprising the cured algae 102 may have an ammonia content, an ammonium content, and/or a total ammoniacal nitrogen that is lower relative to the same fertilizer composition comprising an uncured algae in place of the cured algae 102. For example, the provided fertilizer composition 100 may have an ammonia content, an ammonium content, and/or a total ammoniacal nitrogen that is at least 5 times lower, at least 4 times lower, at least 3 times, at least 2 times, or at least 1.5 times lower relative to the same fertilizer composition comprising an uncured algae in place of the cured algae 102.

In some embodiments, when a plant is grown in the presence of the fertilizer composition 100 comprising the cured algae 102 over a duration (e.g., for at least 10 days, at least 15 days, at least 20 days, to less than 25 days, less than 30 days, less than 35 days, less than 40 days, or less than 45 days), the plant surprisingly and unexpectedly has a higher number of leaves on average (e.g., at least one additional leaf, at least two additional leaves, at least three additional leaves, at least four additional leaves, to less than five additional leaves, or less than ten additional leaves, or more) relative to the same plant grown in the same fertilizer composition comprising an uncured algae in place of the cured algae 102.

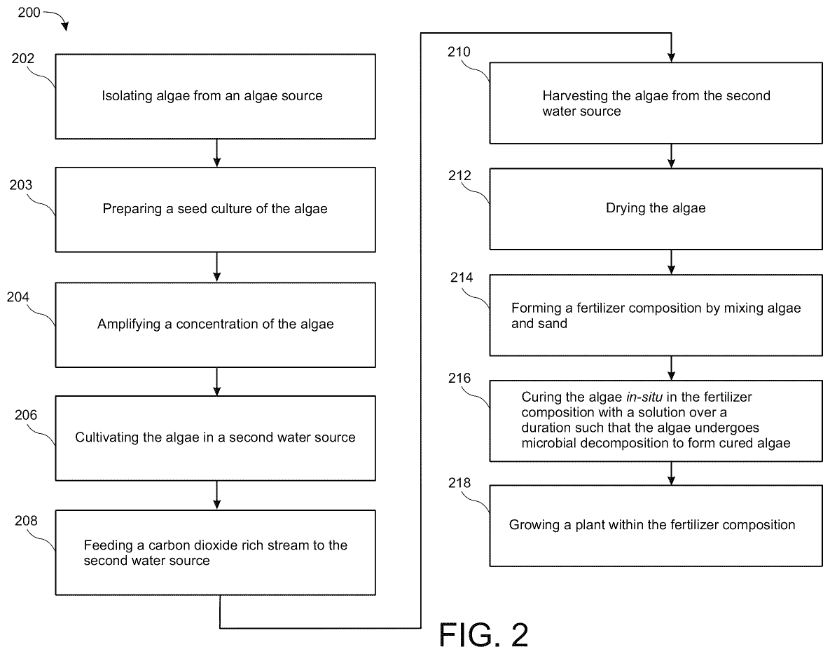

Referring to FIG. 2, a method 200 is provided according to embodiments of the present disclosure. At operation 202, the method 200 includes isolating algae from an algae source. The algae source may be any suitable algae source including, but not limited to, water, soil, damp environments, or a combination thereof. In one embodiment, the algae source is a first water source. In some particular examples, the first water source includes, but is not limited to, fresh water, brackish water, saline water, seawater, hypersaline seawater, treated seawater or wastewater. As used herein, “fresh water” may refer to water that has a concentration of dissolved salts that is less than 0.05% (e.g., 0.5 ppt). As used herein, “brackish water” may refer to water that has a concentration of dissolved salts that ranges between 0.05% to 3% (e.g., 0.5 ppt to 30 ppt). As used herein, “saline water” may refer to water that has a concentration of dissolved salts that ranges from 3% to 5% (e.g., 30 ppt to 50 ppt). As used herein, “seawater” may refer to water that has a concentration of dissolved salts ranging from 3.5% to 4% (e.g., 35 ppt to 40 ppt). As used herein, “hypersaline seawater” may refer to water that has a concentration of dissolved salts that is greater than 5% (e.g., >50 ppt).

As used herein, “wastewater” may refer to any suitable wastewater stream containing sufficient nutrients to grow algae such as municipal waste streams or industrial waste streams. In some particular examples, the wastewater may include, but is not limited to, agricultural runoff, stormwater runoff, wastewater present in ponds or lagoons in wastewater treatment plants, dairy farm wastewater, piggery wastewater, treated sewage treatment (STP) wastewater, raw STP wastewater after primary treatment, or combinations thereof.

As used herein, treated seawater may refer to seawater that has undergone one or more treatment operations, such as filtering suspended solids in the seawater, disinfecting the seawater, deoxygenating the seawater, adjusting the pH of the seawater, or combinations thereof. In some embodiments, filtering the seawater includes passing the seawater through a multimedia filter (e.g., sand, gravel, anthracite), a cartridge or membrane filter (e.g., microfiltration, ultrafiltration), dissolved air flotation, lamella clarification, or combinations thereof. In some embodiments, the treated seawater has a solids concentration of less than 10 mg/L, less than 5 mg/L, less than 1 mg/L, less than 0.2 mg/L, or less than 0.1 mg/L. In some embodiments, deoxygenating the seawater may include one or more deoxygenating operation, such as gas stripping, vacuum deaeration, a wet combustion catalytic process, or combinations thereof. In some embodiments, the treated seawater or deaerated seawater has a dissolved oxygen content of less than 0.5 ppm, less than 0.2 ppm, less than 0.1 ppm, less than 0.05 ppm, or less than 0.01 ppm. In some embodiments, the treated seawater may be generated by performing one or more disinfecting operation, such as adding a disinfectant (e.g., sodium hypochlorite, ozone), treating the seawater with ultraviolet light, or combinations thereof. In some embodiments, the treated seawater is generated by adding an acid or base to adjust the pH to a range from 7.2 to 8.1.

At operation 204, the method 200 includes amplifying a concentration of the algae. For example, amplifying the concentration of the algae may include scaling up the seed cultures of the algae in any suitable apparatus, which may include, but is not limited to, a flask, a photobioreactor (e.g., indoor or outdoor photobioreactor), an open pond, an open raceway pond, or a combination thereof.

At operation 205, the method 200 includes seeding the algae in a second water source. For example, operation 205 may include taking the amplified concentration of the algae from operation 204 and placing the algae in a second water source. Operation 205 may be performed using a single algae strain or multiple algae strains.

At operation 206, the method 200 includes cultivating the algae in the second water source using a nutrient. In some embodiments, the water source is an open pond for cultivating the algae (e.g., an open sabkha pond). In some embodiments, the nutrient includes an organic nutrient (e.g., organic nitrogen, organic phosphorous), an inorganic nutrient (inorganic nitrogen, inorganic phosphorous), a nutrient derived from municipal waste, a nutrient derived from agricultural wastewater, a nutrient derived from industrial wastewater, or a combination thereof.

At operation 208, the method 200 includes feeding a carbon source to the second water source. In some embodiments, feeding the carbon source includes feeding a carbon dioxide rich stream to the second water source. For example, operation 208 may include feeding a carbon dioxide rich product stream or waste stream that is derived from a carbon dioxide source, which may include, but is not limited to, a coal power plant, a natural gas power plant, an anaerobic digestor fermenter, a direct air capture carbon dioxide scrubber, direct air capture from ambient air, or a combination thereof. The carbon dioxide rich stream may be fed to the water source using a carbon dioxide nanobubble generator, a carbonation column, a nano sparger, a bubbler, a diffuser, a microporous tube, a hollow fiber membrane, or a combination thereof. Advantageously, by feeding a carbon rich stream to the algae in the water source, the carbon may be sequestered by the algae, which then may be transferred to the plant when the algae is used in the fertilizer composition 100 during growing. In this way, carbon dioxide that would have otherwise been emitted to the atmosphere may be sequestered by the algae and the plant, thereby reducing the amount of carbon dioxide in the atmosphere. In some embodiments, feeding the carbon source includes feeding an organic carbon source to the second water source. In some embodiments, feeding the carbon source includes feeding an inorganic carbon source to the second water source.

At operation 210, the method 200 includes harvesting algae from the second water source. In some embodiments, the algae in the second water source comprises seawater algae, marine algae, saline water algae, brackish water algae, wastewater algae, freshwater algae, or a combination thereof. The algae may be harvested using any suitable mechanical, mechanoelectrical, chemical, or biological method, which may include, but is not limited to, dissolved air flotation, flocculation, centrifugation, electro flocculation, membrane filtration, or combinations thereof.

At operation 212, the method 200 includes drying the algae. In some embodiments, drying the algae may include solar drying, drum drying, vacuuming drying, or a combination thereof.

At operation 214, the method 200 includes forming a fertilizer composition 100 by mixing algae and sand 104. In some embodiments, operation 214 includes mixing the algae and sand 104 such that the fertilizer composition 100 comprises from 5 wt. % to 50 wt. % algae and from 50 wt. % to 95 wt. % sand 104, based on the total weight of the fertilizer composition 100. In some embodiments, operation 214 further includes mixing from 0.1 wt. % to 25 wt. % compost 106 into the fertilizer composition 100, based on the total weight of the fertilizer composition 100. In some embodiments, operation 204 further includes mixing from 0.1 wt. % to 25 wt. % peat moss 108 into the fertilizer composition 100, based on the total weight of the fertilizer composition 100. In some embodiments, the algae, the sand 104, the compost 106, and/or the peat moss 108 are mixed in a mixer, which can be done in batches or under continuous flow. In some embodiments, operation 214 further includes placing the fertilizer composition 100 in a receptacle or forming a heap, windrow, or bind that comprises the algae and the sand 104. In some embodiments, the receptacle includes seedling bags (e.g., nursery bags), pots, closed reactors or cups. In some embodiments, the heaps or windrows may have a height that ranges from 1 ft to 5 ft.

At operation 216, the method 200 includes curing the algae in-situ within the fertilizer composition 100 with a solution over a duration such that the algae undergoes microbial decomposition to form the cured algae 102. In one particular example, the solution used for operation 216 may include, but is not limited to, distilled water, tap water, fresh water, irrigation quality water, treated sewage, treated industrial wastewater, or a combination thereof. In some embodiments, the irrigation quality water, the treated sewage, and/or the treated industrial wastewater has a pH from 6 to 8.5, a biological oxygen demand (BOD) of less than 40 mg/L, and/or an electrical conductivity (EC) of less than 3 dS/m

In some embodiments, the duration of curing the algae in operation 216 occurs over at least one day to 60 days. In some embodiments, the duration of curing the algae in operation 216 occurs over at least one day, at least two days, at least three days, at least four days, at least five days, at least ten days, to less than 15 days, less than 20 days, less than 25 days, less than 30 days, less than 35 days, less than 40 days, less than 45 days, less than 50 days, less than 55 days, or less than 60 days. In one particular example, the duration of curing the algae in operation 216 occurs from at least 10 to 15 days of curing to reduce growth-inhibitory effects of freshly added algal biomass to the plant.

In some embodiments, operation 216 includes applying the solution once each day over the duration. In some embodiments, operation 216 further includes applying the solution a plurality of times each day over the duration. For example, operation 206 may include applying the solution at least twice a day, at least three times a day, at least five times a day, to less than ten times a day, to less than twenty times a day, or less than thirty times a day.

In some embodiments, at operation 218 the method 200 includes growing a plant within the fertilizer composition 100. For example, the fertilizer composition 100 may be a potting mix configured to receive seeds of the plant or the plant. In some embodiments, operation 218 includes adding the fertilizer composition 100 in a position proximate the plant. In some embodiments, the plant comprises, but is not limited to, a mangrove, an agricultural plant, a horticultural plant, a tree, or a combination thereof.

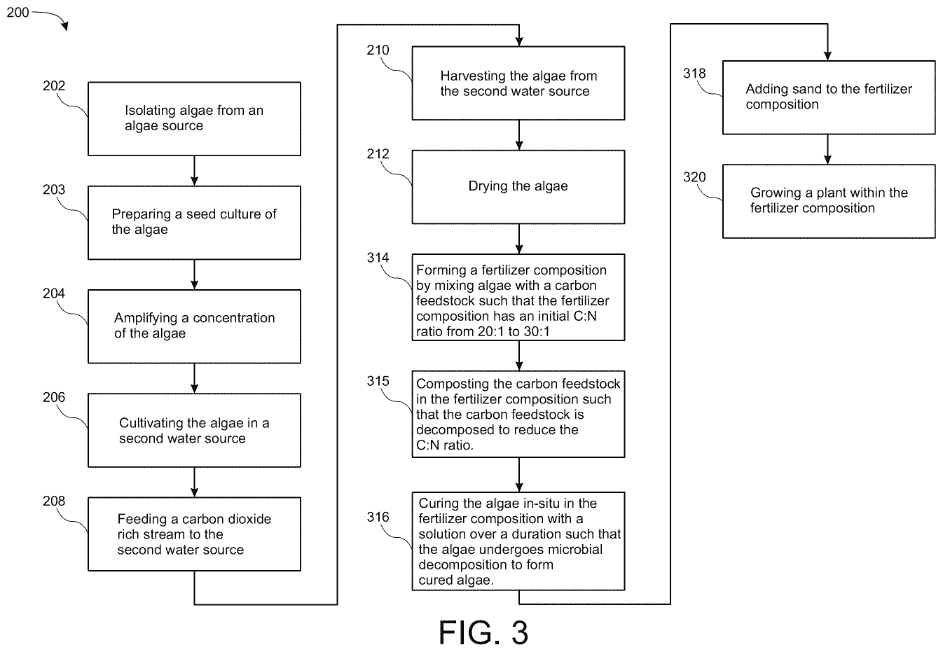

Referring to FIG. 3, a method 300 is provided according to embodiments of the present disclosure. The method 300 includes the same operations 202-212, which are described above with respect to FIG. 2. Following operation 212, the method 300 proceeds to operation 314. At operation 314, the method 300 includes forming a fertilizer composition 100 by mixing algae with either compost or peat moss. In some embodiments, operation 314 includes mixing the algae a carbon feedstock 110 such that the fertilizer composition 100 has an initial carbon to nitrogen (C:N) ratio from 20:1 to 30:1. In some embodiments, the fertilizer composition 100 has an initial C:N ratio of at least 20:1, at least 21:1, at least 22:1, at least 23:1, at least 24:1, at least 25:1, to less than 26:1, less than 27:1, less than 28:1, less than 29:1, less than 30:1 to less than 40:1. In some embodiments, the carbon feedstock 110 includes sawdust, shredded waste paper, shredded waste cartons, plant residue, straw, agricultural waste, industrial waste, food waste, aquaculture waste, or a combination thereof. In some embodiments, the algae is mixed with the carbon feedstock 110 with a mixer, which can be done in batches or under continuous flow. In some embodiments, operation 314 includes placing the fertilizer composition 100 in a receptacle or forming a heap, windrow, or bind that comprises the algae and the carbon feedstock 110. In some embodiments, the receptacle includes a seedling bag (e.g., nursery bags), a pot, a closed reactor or a cup. In some embodiments, the heaps or windrows may have a height that ranges from 1 ft to 5 ft.

At operation 315, the method 300 includes composting the carbon feedstock 110 in the fertilizer composition 100 such that the carbon feedstock 110 is decomposed to reduce the initial C:N ratio. For example, during operation 316, the initial CN ratio may be reduced over the duration such that the fertilizer composition 100 has a final C:N ratio from at least 10:1 to less than 20:1. For example, the final C:N ratio of the fertilizer composition may be from at least 10:1, at least 11:1, at least 12:1, at least 13:1, at least 14:1, to less than 15:1, less than 16:1, less than 17:1, less than 18:1, less than 19:1, or less than 20:1.

At operation 316, the method 300 includes curing the algae in-situ in the fertilizer composition 100 with a solution over a duration such that the algae undergoes microbial decomposition to form cured algae 102 In some embodiments, operation 316 includes curing the algae over a duration that ranges from at least one day to 60 days. In some embodiments, the duration of curing the algae in operation 316 ranges from at least one day, at least two days, at least three days, at least four days, at least five days, at least ten days, to less than 15 days, less than 20 days, less than 25 days, less than 30 days, less than 35 days, less than 40 days, less than 45 days, less than 50 days, less than 55 days, or less than 60 days.

In some embodiments, operation 316 further includes adding the solution to maintain a moisture content from 40% to 60% within the fertilizer composition 100 over the duration. For example, the moisture content may range from at least 40%, at least 45%, to less than 50%, less than 55%, or less than 60%. In some embodiments, operation 316 further includes maintaining a temperature inside the fertilizer composition 100 from 50° C. to 60° C. over the duration. Any suitable heat source may be used to heat the fertilizer composition 100 during operation 316. In some embodiments, operation 316 further includes maintaining a temperature inside the fertilizer composition 100 of at least 40° C., at least 45° C., at least 50° C., at least 52° C., to less than 54° C., less than 56° C., less than 58° C., or less than 60° C. over the duration.

At operation 318, the method 300 includes adding sand 104 to the fertilizer composition 100 such that the cured algae is present in the fertilizer composition in an amount from 5 wt. % to 50 wt. %, based on a total weight of the fertilizer composition 100. In some embodiments, the cured algae 102 is present in the fertilizer composition 100 in an amount from at least 5 wt. %, at least 10 wt. %, at least 15 wt. %, at least 20 wt. %, to less than 25 wt. %, less than 30 wt. %, less than 35 wt. %, less than 40 wt. %, less than 45 wt. %, or less than 50 wt. %, based on the total weight of the fertilizer composition 100. In some embodiments, the sand 104 is present in the fertilizer composition 100 in an amount from 5 wt. % to 95 wt. %, based on the total weight of the fertilizer composition 100. In some embodiments, the sand 104 is present in the fertilizer composition 100 in an amount from at least 5 wt. %, at least 10 wt. %, at least 20 wt. %, at least 30 wt. %, at least 40 wt. %, at least 50 wt. %, at least 55 wt. %, at least 60 wt. %, at least 65 wt. %, at least 70 wt. %, at least 75 wt. %, to less than 80 wt. %, less than 85 wt. %, less than 90 wt. %, or less than 95 wt. %., based on the total weight of the fertilizer composition 100.

In some embodiments, at operation 318 the method 300 includes growing a plant within the fertilizer composition 100. For example, the fertilizer composition 100 may be a potting mix configured to receive seeds of the plant or the plant. In some embodiments, operation 318 includes adding the fertilizer composition 100 in a position proximate the plant. In some embodiments, the plant comprises, but is not limited to, a mangrove, an agricultural plant, a horticultural plant, a tree, or a combination thereof. In some embodiments, operation 318 includes applying the fertilizer composition to soil in an amount from 0.1 tons to 20 tons per hectare of land. In some embodiments, operation 318 includes applying the fertilizer composition to the soil includes forming a potting mix that comprises the soil and the fertilizer composition, wherein the fertilizer composition is present in an amount from 0.1 to 50 wt. %, based on a total weight of the potting mix.

### EXAMPLES

### Example 1

Mangrove trials were initiated with algae grown in brackish wastewater rich in ash/salt content added in the mangrove potting mix in different ratios as given below in Table 1.

TABLE 1
Treatment details

| Treatment | Potting mixture components | Ratio (%) |
|---|---|---|
| C1 | Sand | 100 |
| C2 | Sand:Compost | 70:30 |
| C3 | Sand:Peat | 70:30 |
| T1 | Sand:Algae | 90:10 |
| T2 | Sand:Algae | 80:20 |
| T3 | Sand:Algae | 70:30 |
| T4 | Sand:Algae | 50:50 |
| T5 | Sand:Algae | 40:60 |
| T6 | Sand:Algae:Compost | 70:10:20 |
| T7 | Sand:Algae:Compost | 70:20:10 |
| T8 | Sand:Algae | 80:20 |
| T9 | Sand:Algae | 95:5 |

Except for treatments T8 and T9, all other treatments were sown with mangrove seeds. One-month-old mangroves seedlings were transplanted in treatment bags T8 and T9. All the bags were watered every 12 hours using water with a salinity of 5 g/l (0.5 g/l). All the sown seeds were checked individually for shoot/root growth and number of leaves.

TABLE 2
Effect of addition of C1-C3 in potting mix

| | | | | | | | | | |
|---|---|---|---|---|---|---|---|---|---|
| | | | | | Bulk | | | | |
| | | | | | density | | | | |
| | | | | | of | | | | |
| | | | | | potting | | | | |
| | | | | | mix | Growth / | | | |
| Treatment | | Seed | Treatment | Ratio | (g/cm³ | No | No. of | | Mortality |
| code | Replication | treatment | details* | (%) | or ml) | growth | leaves | Comments | % |

CONTROL TREATMENTS

| | | | | | | | | | |
|---|---|---|---|---|---|---|---|---|---|
| C1 | R1 | Algae | Sand | 100 | 1.26 | Growth observed | 4 | | 33% |
| | | treated | | | | | leaves | | |
| | R2 | Tap water | | | | Dead | None | | |
| | | treated | | | | | | | |
| | R3 | Tap water | | | | Growth observed | 2 | All small leaves | |
| | | treated | | | | | leaves | | |
| C2 | R1 | Algae | Sand:Compost | 70:30 | 0.93 | Dead | | | 50% |
| | | treated | | | | | | | |
| | R2 | Tap water | | | | Growth observed | 3 | | |
| | | treated | | | | | leaves | | |
| | R3 | Tap water | | | | No growth | | Roots observed | |
| | | treated | | | | | | | |
| | R4 | Algae | | | | Growth observed | 6 | | |
| | | treated | | | | | leaves | | |
| | R5 | Algae | | | | 1. Growth | | 2 leaves are small | |
| | | treated | | | | observed | | | |
| | | | | | | 2. Dead | | | |
| | R6 | Algae | | | | 1. Growth | 4 | | |
| | | treated | | | | observed | leaves | | |
| | | | | | | 2. Dead | | | |
| C3 | R1 | Tap water | Sand:Peat | 70:30 | 0.67 | No visible growth | | Roots observed | 14% |
| | | treated | | | | | | | |
| | R2 | Tap water | | | | Growth observed | 4 | | |
| | | treated | | | | | leaves | | |
| | R3 | Algae | | | | Growth observed | 6 | | |
| | | treated | | | | | leaves | | |
| | R4 | Algae | | | | Growth observed | 4 | | |
| | | treated | | | | | leaves | | |
| | R5 | Algae | | | | Growth observed | 5 | | |
| | | treated | | | | | leaves | | |
| | R6 | Algae | | | | Growth observed | 6 | | |
| | | treated | | | | | leaves | | |
| | R7 | Algae | | | | Growth observed | 7 | | |
| | | treated | | | | | leaves | | |

TABLE 3
Effect of addition of T1-T3 in potting mix

| | | | | | | | | | |
|---|---|---|---|---|---|---|---|---|---|
| | | | | | Bulk density | | | | |
| | | | | | of potting | Growth/ | | | |
| Treatment | | Seed | Treatment | Ratio | mix (g/cm3 | No | No. of | | Mortality |
| code | Replication | treatment | details* | (%) | or ml) | growth | leaves | Comments | % |

ALGAE TREATMENTS

| | | | | | | | | | |
|---|---|---|---|---|---|---|---|---|---|
| T1 | R1 | Algae | Sand:Algae | 90:10 | 1.16 | Growth | 1 leaf | Small leaf | 27% |
| | | treated | | | | observed | | | |
| | R2 | Algae | | | | Dead | | Roots observed | |
| | | treated | | | | | | | |
| | R3 | Tap water | | | | 1) Growth | 1) 4 | 1) 2 small leaves | |
| | | treated | | | | observed | leaves | 2) All small | |
| | | | | | | 2) Growth | 2) 2 | leaves | |
| | | | | | | observed | leaves | | |
| | R4 | Tap water | | | | 1) Growth | 1) 2 | 1) Roots observed | |
| | | treated | | | | observed, | leaves | 2) Roots observed | |
| | | | | | | 2) Growth | | | |
| | | | | | | observed | | | |
| | | | | | | 3) Growth | | | |
| | | | | | | observed | | | |
| | R5 | Tap water | | | | 1) Growth | 1) 4 | 1) All small | |
| | | treated | | | | observed | leaves | leaves | |
| | | | | | | 2) Growth | 2) 4 | 2)All small | |
| | | | | | | observed | leaves | leaves | |
| | | | | | | 3) Growth | 3) 2 | 3)All small | |
| | | | | | | observed | leaves | leaves | |
| | R6 | Algae | | | | Growth | 4 leaves | All small leaves | |
| | | treated | | | | observed | | | |
| T2 | R1 | Algae | Sand:Algae | 80:20 | 1.28 | No growth | | | 88% |
| | | treated | | | | | | | |
| | R2 | Algae | | | | No growth | | [symbol] ungal | |
| | | treated | | | | | | infec. observ [symbol] | |
| | R3 | Tap water | | | | 1) No growth | 2) 2 | 3)Fungal | |
| | | treated | | | | 2) Growth | leaves | infection | |
| | | | | | | observed | | observed | |
| | | | | | | | | 4)All leaves are | |
| | | | | | | | | small | |
| | R4 | Tap water | | | | Dead | | | |
| | | treated | | | | | | | |
| | R5 | Algae | | | | Dead | | | |
| | | treated | | | | | | | |
| | R6 | Algae | | | | Dead | | Roots observed | |
| | | treated | | | | | | | |
| | R7 | Algae | | | | Dead | | | |
| | | treated | | | | | | | |
| T3 | R1 | Algae | Sand:Algae | 70:30 | 0.83 | Dead | | Roots observed | 100% |
| | | treated | | | | | | | |
| | R2 | Tap water | | | | Dead | | | |
| | | treated | | | | | | | |
| | R3 | Algae | | | | Dead | | | |
| | | treated | | | | | | | |
| | R4 | Tap water | | | | Dead | | | |
| | | treated | | | | | | | |
| | R5 | Algae | | | | Dead | | | |
| | | treated | | | | | | | |

[symbol]

indicates data missing or illegible when filed

TABLE 4
Effect of the addition of T4-T6 in the potting mix.

| | | | | | | | | | |
|---|---|---|---|---|---|---|---|---|---|
| | | | | | Bulk | | | | |
| | | | | | density | | | | |
| | | | | | of | | | | |
| | | | | | potting | | | | |
| | | | | | mix | Growth/ | | | |
| Treatment | | Seed | Treatment | Ratio | (g/cm3 | No | No. of | | Mortality |
| code | Replication | treatment | details* | (%) | or ml) | growth | leaves | Comments | % |

ALGAE TREATMENTS

| | | | | | | | | | |
|---|---|---|---|---|---|---|---|---|---|
| T4 | R1 | Algae | Sand:Algae | 50:50 | 1.01 | Dead | | | 100% |
| | | treated | | | | | | | |
| | R2 | Tap water | | | | Dead | | | |
| | | treated | | | | | | | |
| | R3 | Tap water | | | | Dead | | | |
| | | treated | | | | | | | |
| T5 | R1 | Tap water | Sand:Algae | 40:60 | 0.76 | Dead | | | 100% |
| | | treated | | | | | | | |
| | R2 | Algae | | | | Dead | | Black color | |
| | | treated | | | | | | | |
| | R3 | Algae | | | | Dead | | Black color | |
| | | treated | | | | | | | |
| | R4 | Tap water | | | | Dead | | Black color | |
| | | treated | | | | | | | |
| T6 | R1 | Tap water | Sand:Algae:Compost | 70:10:20 | 1.16 | No growth | | Roots | 25% |
| | | treated | | | | | | observed | |
| | R2 | Algae | | | | Growth | 4 leaves | 2 small | |
| | | treated | | | | observed | | leaves | |
| | R3 | Tap water | | | | Growth | 4 leaves | | |
| | | treated | | | | observed | | | |
| | R4 | Tap water | | | | Growth | 4 leaves | | |
| | | treated | | | | observed | | | |
| T7 | R1 | Tap water | Sand:Algae:Compost | 70:20:10 | | Dead | | | 100% |
| | | treated | | | | | | | |
| | R2 | Algae | | | | Dead | | | |
| | | treated | | | | | | | |
| | R3 | Algae | | | | Dead | | | |
| | | treated | | | | | | | |

TRANSPLANTED SEEDLINGS IN ALGAE TREATMENTS

| | | | | | | |
|---|---|---|---|---|---|---|
| T8 | R1 | Sand:Algae | 80:20 | 1.28 | Dead | |
| | | Transplanted | | | | |
| T9 | R1 | Sand:Algae | 95:5 | | No growth | Dying |
| | | Transplanted | | | | |

One objective of Example 1 was test the effect of the addition of algal biomass without curing in different concentrations viz. 10%, 20%, 30%, 50%, and 60% to replace the conventional compost/cow manure, peat moss, and sand in the potting mixture. Algal biomass used for the trials was harvested from the static pond with treated brackish wastewater (Salinity about 10 ppt). In general, untreated algal biomass (i.e., uncured algae) incorporated in the potting mix recorded slow growth and higher mortality %. Among all the algae treatments, the combination of Sand and Algae at the proportion of 90:10 recorded a 27% mortality rate, a relatively good survival rate but with slow growth. Transplanted treatments with 20% algae content did not survive but treatments with 5% algae content survived but with slow growth. These preliminary results confirmed that the algal biomass added to the potting mix should have water curing to prevent high acidity, high alkalinity due to ammonia production, high salinity/electrical conductivity, high temperature due to exothermic decomposition reactions, oxygen depletion in the root zone and build-up of growth-inhibitory substances.

### Example 2

Growth performance of mangroves in the potting mix containing algae biocarbon fertilizer was tested without curing. Mangrove trials were initiated with treatments as given in Table 5. Mangrove seeds were sown in the potting mix containing algae biocarbon fertilizer without curing. All the bags were watered every 12 hours using water with a salinity of 5 g/l. All the sown seeds were checked individually for shoot/root growth and a number of leaves.

TABLE 5
Mangrove growth trials and treatment details.

| Treatment code | Treatment details |
|---|---|
| C1 | 100% Sand treatment |
| C2 | 70:30 Sand:Compost treatment |
| C3 | 70:30 Sand:Peat treatment |
| T1 | 90:10 Sand:Algae treatment |
| T2 | 80:20 Sand:Algae treatment |
| T3 | 70:30 Sand:Algae treatment |
| T4 | 50:50 Sand:Algae treatment |
| T5 | 40:60 Sand:Algae treatment |
| T6 | 70:10:20 Sand:Algae:Compost treatment |
| T7 | 70:20:10 Sand:Algae:Compost treatment |

It was observed that the control treatments C3 (70:30, sand:peat) & C1 (100% sand) and the algae treatments T1 (90:10 sand:algae) & T6 (70:10:20, sand:algae; compost) recorded the lowest mortalities, as shown in table 6.

TABLE 6
Mortality % of mangrove seedlings in different treatments

| Treatment | Average Mortality (%) |
|---|---|
| C1 (100% S) | 33 |
| C2 (70:30 S:C) | 50 |
| C3 (70:30 S:P) | 14 |
| T1 (90:10 S:A) | 27 |
| T2 (80:20 S:A) | 88 |
| T3 (70:30 S:A) | 100 |
| T4 (50:50 S:A) | 100 |
| T5 (40:60 S:A) | 100 |
| T6 (70:10:20 S:A:C) | 25 |
| T7 (70:20:10 S:A:C) | 100 |

It was observed that the control treatments C2 (70:30 sand:compost) and C3 (70:30 sand:peat) recorded maximum growth among surviving seedlings while T6 (70:10:20 sand:algae:compost) showed maximum growth among all the algae treatments, as shown in Table 7.

TABLE 7
Shoot, root, and total length of mangrove
seedlings in different treatmetns

| | Average root | Average shoot | Average total |
|---|---|---|---|
| Treatments | length (cm) | length (cm) | length (cm) |
| C1 (100% S) | 4.2 | 8.2 | 12.5 |
| C2 (70:30 S:C) | 6.6 | 11.4 | 18 |
| C3 (70:30 S:P) | 6.3 | 13.1 | 19.4 |
| T1 (90:10 S:A) | 3.8 | 6.4 | 10.1 |
| T2 (80:20 S:A) | 3 | 3.4 | 5.5 |
| T3 (70:30 S:A) | 5 | 3.5 | 8.5 |
| T4 (50:50 S:A) | 0 | 0 | 0 |
| T5 (40:60 S:A) | 0 | 0 | 0 |
| T6 (70:10:20 | 5.5 | 8.1 | 13.6 |
| S:A:C) | | | |
| T7 (70:20:10 | 0 | 0 | 0 |
| S:A:C) | | | |

It was observed that the control treatments C2 and C3 had the highest number of leaves among surviving saplings while T6 had the highest number of leaves among all the algae treatments. Overall, the number and size of leaves in the algae (without curing) treatments were noticeably lower and smaller when compared to the seedlings in the control treatment.

TABLE 8
Number of leaves in the mangrove seedlings
grown under different treatments

| Treatment | Average number of leaves |
|---|---|
| C1 (100% S) | 5 |
| C2 (70:30 S:C) | 5 |
| C3 (70:30 S:P) | 7 |
| T1 (90:10 S:A) | 3.9 |
| T2 (80:20 S:A) | 3 |
| T3 (70:30 S:A) | 4 |
| T4 (50:50 S:A) | 0 |
| T5 (40:60 S:A) | 0 |
| T6 (70:10:20 S:A:C) | 4.5 |
| T7 (70:20:10 S:A:C) | 0 |

Various observations were recorded over 12 weeks. The algal biomass used in this Example was cultivated and harvested from the brackish treated wastewater with a salinity range of 5-10 g/l and contained more than 50% ash. Utilizing microalgae cultivated in saline or brackish or wastewater sources as an organic amendment in the potting mix to improve the growth of mangroves is contemplated to be new. Algal biomass harvested from the brackish sewage-treated effluent was obtained from a consortium of algal strains. Algae treatment T6 (70:10:20 sand:algae:compost) performed better when compared to all other algae treatments and the growth performance of seedlings in this treatment was comparable to all three controls. Though the algal biomass used in the algae treatments was not cured, treatments T1 (90:10 sand:algae) and T6 (70:10:20 sand:algae:compost) without curing recorded the best growth performance among all the other algae treatments.

### Example 3

In-situ curing of algal biomass in the mangrove potting mix was tested. Treatment details of the experiment are given in the table 9 below. After mixing algal biomass in different proportions in the potting mix, all the bags in each treatment were cured for 5, 10, 15, and 30 days by spraying them with fresh water 2 times every day. For control, no curing was done. All the bags in each treatment with a potting mix containing algae and compost were kept in an open environment. For each treatment, triplicate samples were prepared.

TABLE 9
Treatment details of algae in-situ curing (30 days)

| | | | | | | | | Total | | | | |
|---|---|---|---|---|---|---|---|---|---|---|---|---|
| | Treatment | | | Treatment Details | | | | no of | Algal | | | |
| | details | | | | | | Peat | bags/ | biomass | Sand | Compost | Peat |
| | (Algae:Sand:Compost:Peat | Treatment | Curing | Algae | Sand | Compost | moss | each | required | required | required | required |
| Group | ratio) | ID | treatments | (%) | (%) | (%) | (%) | treatment | (kg) | (kg) | (kg) | (kg) |
| C1 | 0:70:30:0 | C1-A | No curing | 0 | 70 | 30 | 0 | 3 | 0 | 2.1 | 0.9 | 0 |
| | | C1-B | 5 days | | | | | 3 | 0 | 2.1 | 0.9 | 0 |
| | | C1-C | 10 days | | | | | 3 | 0 | 2.1 | 0.9 | 0 |
| | | C1-D | 15 days | | | | | 3 | 0 | 2.1 | 0.9 | 0 |
| | | C1-E | 30 days | | | | | 3 | 0 | 2.1 | 0.9 | 0 |
| SUB TOTAL | | | | | | | | | 0 | 10.5 | 4.5 | 0 |
| T1 | 5:70:25:0 | T1 -A | No curing | 5 | 70 | 25 | 0 | 3 | 0.15 | 2.1 | 0.75 | 0 |
| | | T1 -B | 5 days | | | | | 3 | 0.15 | 2.1 | 0.75 | 0 |
| | | T1 -C | 10 days | | | | | 3 | 0.15 | 2.1 | 0.75 | 0 |
| | | T1 -D | 15 days | | | | | 3 | 0.15 | 2.1 | 0.75 | 0 |
| | | T1 -E | 30 days | | | | | 3 | 0.15 | 2.1 | 0.75 | 0 |
| SUB TOTAL | | | | | | | | | 0.75 | 10.5 | 3.75 | 0 |
| T2 | 10:70:20:0 | T2 -A | No curing | 10 | 70 | 20 | 0 | 3 | 0.3 | 2.1 | 0.6 | 0 |
| | | T2 -B | 5 days | | | | | 3 | 0.3 | 2.1 | 0.6 | 0 |
| | | T2 -C | 10 days | | | | | 3 | 0.3 | 2.1 | 0.6 | 0 |
| | | T2 -D | 15 days | | | | | 3 | 0.3 | 2.1 | 0.6 | 0 |
| | | T2 -E | 30 days | | | | | 3 | 0.3 | 2.1 | 0.6 | 0 |
| SUB TOTAL | | | | | | | | | 1.5 | 10.5 | 3 | 0 |
| T3 | 20:70:10:0 | T3 -A | No curing | 20 | 70 | 10 | 0 | 3 | 0.6 | 2.1 | 0.3 | 0 |
| | | T3 -B | 5 days | | | | | 3 | 0.6 | 2.1 | 0.3 | 0 |
| | | T3 -C | 10 days | | | | | 3 | 0.6 | 2.1 | 0.3 | 0 |
| | | T3 -D | 15 days | | | | | 3 | 0.6 | 2.1 | 0.3 | 0 |
| | | T3 -E | 30 days | | | | | 3 | 0.6 | 2.1 | 0.3 | 0 |
| SUB TOTAL | | | | | | | | | 3 | 10.5 | 1.5 | 0 |
| T4 | 30:70:0:0 | T4 -A | No curing | 30 | 70 | 0 | 0 | 3 | 0.9 | 2.1 | 0 | 0 |
| | | T4 -B | 5 days | | | | | 3 | 0.9 | 2.1 | 0 | 0 |
| | | T4 -C | 10 days | | | | | 3 | 0.9 | 2.1 | 0 | 0 |
| | | T4 -D | 15 days | | | | | 3 | 0.9 | 2.1 | 0 | 0 |
| | | T4 -E | 30 days | | | | | 3 | 0.9 | 2.1 | 0 | 0 |
| SUB TOTAL | | | | | | | | | 4.5 | 10.5 | 0 | 0 |
| T5 | 50:50:0:0 | T5 -A | No curing | 50 | 50 | 0 | 0 | 3 | 1.5 | 1.5 | 0 | 0 |
| | | T5 -B | 5 days | | | | | 3 | 1.5 | 1.5 | 0 | 0 |
| | | T5 -C | 10 days | | | | | 3 | 1.5 | 1.5 | 0 | 0 |
| | | T5 -D | 15 days | | | | | 3 | 1.5 | 1.5 | 0 | 0 |
| | | T5 -E | 30 days | | | | | 3 | 1.5 | 1.5 | 0 | 0 |

| | | | | |
|---|---|---|---|---|
| SUB TOTAL | 7.5 | 7.5 | 0 | 0 |
| TOTAL | 17.25 | 60 | 12.75 | 0 |

pH, Electrical conductivity (EC), Salinity, Nitrate, Ammonia, Ammonium, and Total ammoniacal nitrogen were determined in the samples collected from the potting mix on days 0, 5, 10, 15, and 30. pH, EC, salinity, and EC were measured using the extract containing potting mix and water in a 1:5 ratio. To prepare the extract, a small quantity of a representative sample from the potting mixture was collected from each treatment. A known quantity (5 g) of this sample was then added to a container with 25 mL of distilled water and mixed well. After thorough mixing, the supernatant was separated and it was used for the measurement of pH. EC and salinity were determined. Total ammoniacal nitrogen (Ammonia+Ammonium) and nitrate analyses were carried out using a Hach spectrophotometer. Temperature changes inside the potting mix in the bags were measured for all the treatments.

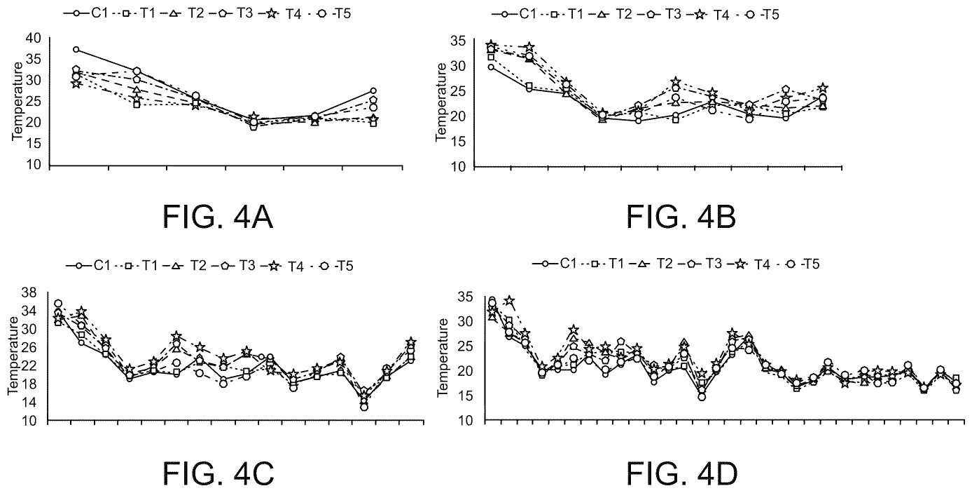

Referring to FIGS. 4A-4D, Initial temperature recorded was 29.3 C for the control with compost and 31.3, 31.7, 31.9, 36.8 and 31.3 C for the treatments T1, T2, T3 and T4 with algae, respectively. At the end of 5 days of curing, there was 29%, 35%, 33%, 21%, 25%, and 25% reduction in the temperature recorded for the treatment C1, T1, T2, T3, and T4, respectively when compared to the temperature on Day 0. After 30 days of curing, a 42-51% reduction in the temperature was observed in the mangroves potting mix when compared to the temperature recorded on day 0. Reduction in the temperature indicates the stabilization of the organic matter in the algae treatments. Curing or application of water accelerates microbial decomposition and helps in stabilizing the organic matter present in the algal biomass.

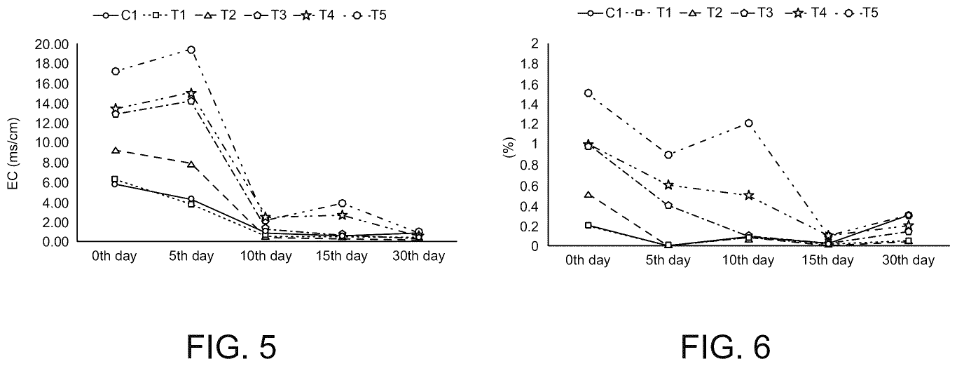

FIG. 5 illustrates pH changes in the mangrove potting mix with algae (T1-T5). As shown in FIG. 5, pH of the potting mix with algae ranged between 8.26 and 9.03 on day 0 and the average pH for all the algae treatments was 8.63. Control with compost recorded a pH value of 9.78 on day 0 before initiating the curing treatment. Average pH of all the treatments with algae on days 5, 10, 15, and 30 was 8.70, 8.50, 8.61, and 9.40, respectively. pH of control with compost on days 5, 10, 15, and 30 was 7.57, 8.80, 9.05, and 9.14, respectively. On day 10, the pH drop in all treatments varied from 8.33 to 8.80. The decline in pH observed could be due to the volatilization of ammoniacal nitrogen coupled with the release of hydrogen ions (H+) through the nitrification activities of nitrifying bacteria, as well as the emission of large volumes of carbon dioxide due to the decomposition of organic matter in the algal biomass and compost.

FIG. 5 illustrates changes in electrical conductivity (EC) and FIG. 6 illustrates changes in salinity of mangrove potting mix with algae (T1-T5) during curing. As shown in FIGS. 5-6, EC decreased from 5.85 to 0.91 mS/cm, 6.28 to 0.23 mS/cm, 9.19 to 0.23 mS/cm, 12.90 to 0.41 mS/cm, 13.41 to 0.65 mS/cm and 17.17 to 0.76 mS/cm in C1, T1, T2, T3, T4, and T5, respectively over the curing period. In the initial “no curing” treatment (day 0), EC and salinity values were high. During curing, EC and salinity values showed a decreasing trend due to the leaching of soluble salts present in the algal biomass in the treatments and compost in the control because of water application. Compared to the control, T3, T4 and T5 algae treatments recorded higher EC and salinity values. Higher EC and salinity values may inhibit seed germination and root growth. Curing treatment proved that the leaching of salts during water applications drastically reduced the EC and salinity in the algae treatments. Sowing of seeds in the algae potting mix without curing, may inhibit seed germination and inhibit the growth of mangrove seedlings.

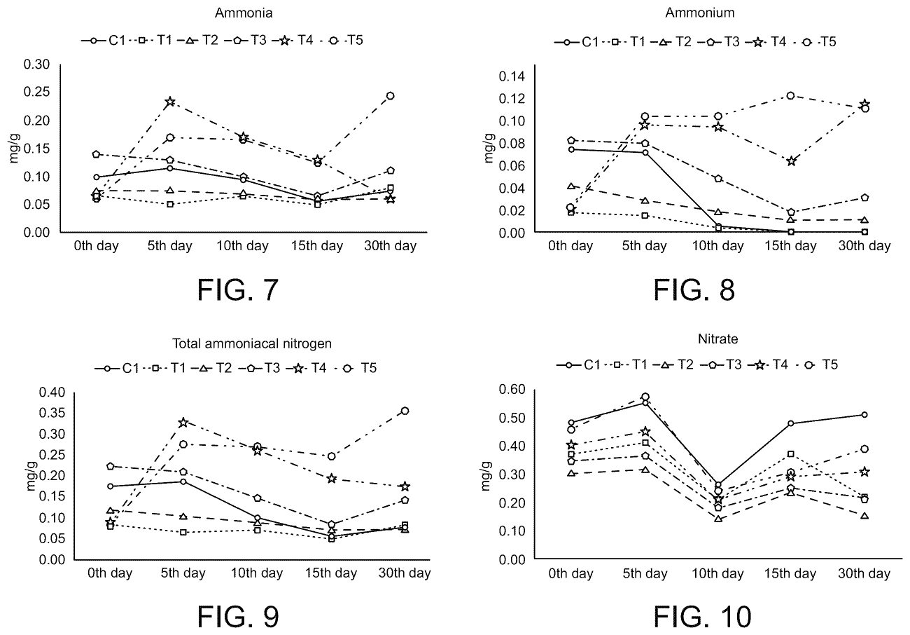

FIG. 7 illustrates ammonia content, FIG. 8 illustrates ammonium content, FIG. 9 illustrates total ammoniacal nitrogen, and FIG. 10 illustrates nitrate content, respectively, in the mangrove potting mix with algae (T1-T5) during curing. As shown in FIGS. 7-10, average total ammonia, total ammonium and total ammoniacal nitrogen values were reduced to 34-35% on the 15th day of curing when compared to the concentration present on day 5 in all the algae treatments. Ammonia concentration in the treatments T2, T3, T4 and T5 containing algae showed a decreasing trend from day 5 to day 15. Ammonium (NH₄—N) concentration in the treatments T1, T2, T3, and T4 showed a decreasing trend from day 5 to day 15. Ammonia (NH₃) and ammonium (NH₄) are the by-products of microbial decomposition of organic matter present in algae. When ammonia and ammonium concentration increase in the root zone, it can be toxic. Ammonia and ammonium ion toxicity symptoms include reduced plant growth, changes in root architecture, decreases in the root/shoot ratio, leaf chlorosis, inhibition of cations (K⁺, Mg²⁺ or Ca²⁺) uptake and consequent changes in plant ion balance, intra-cellular alkalinization, extracellular acidification, inhibition of root respiration, stimulation of photorespiration, interference with photosynthetic activity, altered expression/activity of ammonia/ammonium assimilating enzymes, disruption of hormonal homeostasis, increased oxidative stress, and high energy cost to maintain low levels of cytosolic ammonium content.

It was observed that all the mangrove seeds sown in the treatments containing uncured algae at different concentrations recorded no growth or no germination due to inhibitory effects caused by ammonia and ammonium. In-situ curing addresses these aforementioned technical challenges. FIGS. 7-8 show that the concentration of ammonium and ammonia decreased due to curing treatment after 5 days of curing. Curing promotes the conversion of ammonia to nitrate. FIG. 10 shows the changes in the nitrate concentration in the potting mix during curing. FIG. 10 shows that the nitrate concentration in the algae treatments T1, T2, T3, T4, and T5 showed 5, 8, 18, 49, and 63% increase, respectively on day 30 when compared to day 10. Curing promotes the conversion of toxic ammonia-based compounds to nitrate which is a preferred form of plant nutrient. During curing, the ammonia concentration decreases, and nitrate concentration increases in the algae treatments. However, on 30th day, the ammonia/ammonium concentration increased in a few algae treatments. It could be due to the anaerobic conditions created by continuous rains saturating all pore spaces in the potting mix. Rainwater occupying all pores would have prevented the circulation of air and prevented the oxidation of ammonia to nitrate. In general, in-situ curing promotes the reduction of ammonia and increases nitrate content in the potting mix added with algae.

In-situ curing was developed to use poor quality algal biomass cultivated in seawater and brackish water as biocarbon fertilizer in the mangrove potting mix. Use of fresh algal biomass as biocarbon fertilizer is not recommended. Curing trials of algal biomass added in the mangroves potting mix at different concentrations viz. 5, 10, 20, 30, and 50% were conducted. In-Situ curing of algal biomass carried out with freshwater by applying water on the potting mix two times a day. Effect of 5, 10, 15, and 30 days of curing with water was evaluated by monitoring the changes in the temp, pH, EC, salinity, ammonia-N, ammonium-N, and total ammoniacal nitrogen. This Example illustrated that curing has a significant impact on the temperature, EC, salinity, ammonia, ammonium, and nitrate content in the mangrove potting mix added with algal biomass at different concentrations. Curing leached-out salts present in the algal biomass and significantly reduced the EC and salinity in all treatments added with algae. Fresh algal biomass added to the potting mix or soil readily undergoes decomposition upon wetting. Decomposition accelerates the release of ammonia and ammonium and increases the concentration of ammonia and ammonium in the root zone. Ammonia and ammonium release at higher concentrations during the initial phase of decomposition significantly impacts the germination of seeds, growth of roots, and growth of plants. However, in this Example it is noticed that the concentration of ammonia and ammonium was significantly reduced during the curing between day 5 and day 15. Similarly, curing favors microbial activity and converts ammonia to nitrate which is considered beneficial. Thus, the in-situ curing approach developed is unique and has been evaluated for the first time to assess the potential of algal biomass rich in carbon and nitrogen but with high ash content as a potential biofertilizer in the mangrove potting mix to promote the growth of mangroves.

### Example 4

Growth performance of mangrove seedlings added with algal biomass cured or composted over 45 days. One objective of this Example was to assess the growth performance of mangrove seedlings transplanted in the potting mix containing 45 days of cured or composted algal biomass. Treatment details of the Example are provided in Table 10. All the bags with one-month-old transplanted mangrove seedlings were watered every 24 hours with fresh water. All the transplanted seedlings were checked individually for growth performance and number of leaves.

TABLE 10
Mangrove growth trails and treatment details.

| Treatment code | Treatment details |
|---|---|
| C1 | 100% Sand treatment |
| C2 | 100% Peat treatment |
| C3 | 100% Compost treatment |
| C4 | 70:30 Sand:Peat |
| C5 | 70:30 Sand:Compost |
| T1* | 95:5 Sand:Algae |
| T2* | 80:20 Sand:Algae |
| T3* | 70:30 Sand:Algae |
| T4* | 50:50 Sand:Algae |
| T5* | 70:20:10 Sand:Algae:Compost |

TABLE 11
Weather data during experimental period.

| Average high | Average Low | Average | Average |
|---|---|---|---|
| temperature | temperature | humidity | precipitation |
| (° C.) | (° C.) | (%) | (mm) |
| 22.3 | 16.2 | 65 | 11 |
| 20 | 14.1 | 61.5 | 15 |

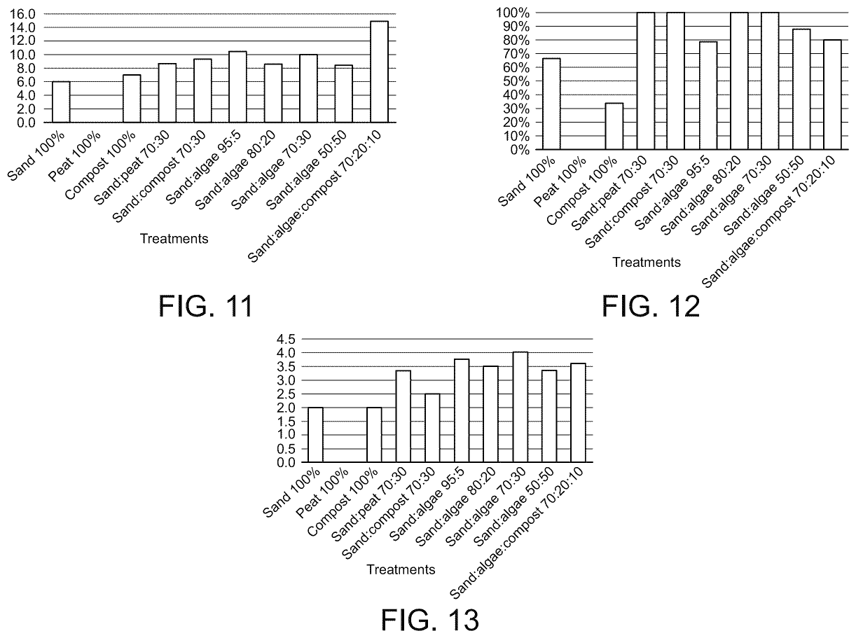

FIG. 11 illustrates average shoot length of mangrove seedlings in control and treatments, FIG. 12 illustrates average survival % of mangrove seedlings in control and treatments, and FIG. 13 illustrates average number of leaves in mangrove seedlings in control and treatments. The algae treatments overall had higher average shoot lengths of 10.4 cm as compared to the controls which had average shoot lengths of just 7.8 cm taking only the surviving plants into account. The algae treatments recorded an average survival rate of 89%. Treatment T5 with sand:algae:compost in the ratio of 70:20:10 recorded the best growth performance in terms of highest shoot length whereas Treatment T3 with sand:algae in the ratio of 70:30 produced more leaves. All algae treatments on average had more than 3 leaves with an average of 3.6, as compared to 2.5 for the controls. This Example shows 20-30% of compost or peat can be replaced by algal biomass cultivated in the brackish water/seawater/wastewater in the mangrove potting mix, and Algal biomass can be used as a beneficial biofertilizer for mangroves after curing and stabilization.

What is claimed is:

1. A method comprising:
forming a fertilizer composition by mixing algae and sand, wherein:
the algae on dry weight basis is present in the fertilizer composition in an amount from 5 wt. % to 50 wt. %, based on a total weight of the fertilizer composition;
the sand is present in the fertilizer composition in an amount from 50 wt. % to 95 wt. %, based on the total weight of the fertilizer composition; and
curing the algae in-situ within the fertilizer composition with a solution over a duration such that the algae undergoes microbial decomposition to form cured algae.

2. The method of claim 1 further comprising growing a plant within the fertilizer composition.

3. The method of claim 1, wherein prior to forming the fertilizer composition, the method further comprises:
isolating the algae from a first water source;
preparing a seed culture comprising the algae;
amplifying a concentration of the algae;
seeding a second water source with the algae;
cultivating the algae in a second water using a nutrient; and
feeding a carbon source to the second water source.

4. The method of claim 3, wherein the nutrient comprises an organic nutrient, an inorganic nutrient, a nutrient derived from municipal waste, a nutrient derived from agricultural wastewater, a nutrient derived from industrial wastewater, or a combination thereof.

5. The method of claim 3, wherein the first water source comprises fresh water, brackish water, saline water, seawater, hypersaline seawater, deaerated seawater, treated seawater, or wastewater.

6. The method of claim 3, wherein feeding the carbon source to the second water stream includes one or more of the following:
feeding a carbon dioxide rich product or a carbon dioxide rich waste stream from one or more members selected from: a coal power plant, a natural gas power plant, an anaerobic digestor fermenter, a direct air capture carbon dioxide scrubber, direct air capture from ambient air, or a combination thereof;
feeding an organic carbon source to the second water source;
feeding an inorganic carbon source to the second water source; or
a combination thereof.

7. The method of claim 3 further comprising:
harvesting the algae from the second water source, wherein comprises seawater algae, marine algae, saline water algae, brackish water algae, wastewater algae, freshwater algae, or a combination thereof;
wherein the algae comprises ash in an amount from 30 wt. % to 80 wt %, based on a total dry matter weight of the algae; and
drying the algae prior to forming the fertilizer composition.

8. The method of claim 1, wherein forming the fertilizer composition further comprises mixing compost or peat moss in the fertilizer composition, and wherein the compost or the peat moss is present in the fertilizer composition in an amount from 0.1 wt. % to 25 wt. %.

9. The method of claim 1, wherein the duration of curing the algae occurs over one day to 60 days, one day to 45 days, five days to 30 days, or over 10 days to 15 days.

10. The method of claim 8, wherein curing the algae in-situ within the fertilizer composition further comprises:
applying the solution a plurality of times each day over the duration.

11. The method of claim 1, wherein forming the fertilizer composition further includes:
placing the algae and the sand in a receptacle; or
forming a heap or windrow that comprises the algae and the sand.

12. The method of claim 11, wherein the receptacle includes a closed reactor, a seedling bag, a pot, or a cup.

13. A method comprising:
forming a fertilizer composition by mixing algae with a carbon feedstock, wherein the fertilizer composition has an initial C:N ratio from 20:1 to 40:1;
composting the carbon feedstock in the fertilizer composition, wherein during composting the carbon feedstock is decomposed to reduce the initial C:N ratio;
curing the algae in-situ in the fertilizer composition with a solution over a duration such that the algae undergoes microbial decomposition to form cured algae;
adding sand to the fertilizer composition, wherein:
the cured algae on a dry weight basis is present in the fertilizer composition in an amount from 5 wt. % to 50 wt. %, based on a total weight of the fertilizer composition; and
the sand is present in the fertilizer composition in an amount from 5 wt. % to 95 wt. %, based on the total weight of the fertilizer composition.

14. The method of claim 13 further comprising growing a plant within the fertilizer composition.

15. The method of claim 13, wherein composting the fertilizer composition over the duration further includes composting until the fertilizer composition has a final C:N ratio from at least 10:1 to less than 20:1.

16. The method of claim 13, wherein the carbon feedstock comprises sawdust, shredded waste paper, shredded waste cartons, plant residue, straw, agricultural waste, industrial waste, food waste, aquaculture waste, or a combination thereof.

17. The method of claim 13, wherein curing the algae over the duration further includes curing the algae over one day to 60 days, one day to 45 days, five days to 30 days, or over 10 days to 15 days.

18. The method of claim 13, wherein curing the algae in-situ in the fertilizer composition with the solution further includes:
adding the solution to maintain a moisture content from 40% to 60% within the fertilizer composition over the duration.

19. The method of claim 13, wherein curing the algae in-situ in the fertilizer composition with the solution further includes:
maintaining a temperature inside the fertilizer composition from 40° C. to 60° C. over the duration.

20. The method of claim 13, wherein prior to forming the fertilizer composition, the method further comprises:
isolating the algae from a first water source;
preparing a seed culture comprising the algae;
amplifying a concentration of the algae;
seeding a second water source with the algae;
cultivating the algae in the second water source using a nutrient;
feeding a carbon source to the second water source;
harvesting the algae from the water source; and
drying the algae prior to forming the fertilizer composition.

21. The method of claim 20, wherein the nutrient comprises an organic nutrient, an inorganic nutrient, a nutrient derived from municipal waste, a nutrient derived from agricultural wastewater, a nutrient derived from industrial wastewater, or a combination thereof.

22. The method of claim 20, wherein the first water source comprises fresh water, brackish water, saline water, seawater, deaerated seawater, treated seawater, produced water, or wastewater.

23. The method of claim 20, wherein feeding the carbon source to the second water source includes one or more of the following:
feeding a carbon dioxide rich product or a carbon dioxide rich waste stream from one or more members selected from: a coal power plant, a natural gas power plant, an anaerobic digestor fermenter, a direct air capture carbon dioxide scrubber, direct air capture from ambient air, or a combination thereof;
feeding an organic carbon source to the second water source;
feeding an inorganic carbon source to the second water source; or
a combination thereof.

24. The method of claim 13 further comprising:
applying the fertilizer composition to soil in an amount from 0.1 tons to 20 tons per hectare of land.

25. The method of claim 24, wherein applying the fertilizer composition to the soil includes forming a potting mix that comprises the soil and the fertilizer composition, wherein the fertilizer composition is present in an amount from 0.1 to 50 wt. %, based on a total weight of the potting mix.

26. A fertilizer composition comprising:
cured algae on a dry weight basis in an amount from 5 wt. % to 50 wt. %, based on a total weight of the fertilizer composition;
sand in an amount from 5 wt. % to 95 wt. %, based on the total weight of the fertilizer composition; and
wherein the cured algae comprises algae that is cured in-situ within the fertilizer composition with a solution over a duration such that the algae undergoes microbial decomposition to form the cured algae.

27. The fertilizer composition of claim 26, wherein the cured algae comprises seawater algae, marine algae, saline water algae, brackish water algae, wastewater algae, freshwater algae, or a combination thereof.

28. The fertilizer composition of claim 26, wherein the cured algae comprises ash, wherein the ash is present in an amount from 30 wt. % to 80 wt %, based on a total dry matter weight of the cured algae.

29. The fertilizer composition of claim 26, wherein, when the fertilizer composition containing the cured algae exposed to water, the ammonia content, ammonium content, or total ammoniacal nitrogen is lower compared to the same fertilizer composition containing uncured algae instead of the cured algae.

30. The fertilizer composition of claim 26, wherein when a plant is grown in the fertilizer composition comprising the cured algae, the plant has a higher number of leaves relative to the same plant grown in the same fertilizer composition comprising an uncured algae instead of the cured algae.

31. The fertilizer composition of claim 24, wherein the sand comprises red sand or yellow sand.
